(19) United States
(12) Patent Application Publication
(10) Pub. No.: US 2022/0366609 A1
(43) Pub. Date: Nov. 17, 2022

(54) DECODING APPARATUS, ENCODING APPARATUS, DECODING METHOD, ENCODING METHOD, AND PROGRAM

(71) Applicant: NIPPON TELEGRAPH AND TELEPHONE CORPORATION, Tokyo (JP)

(72) Inventors: Yukihiro BANDO, Musashino-shi, Tokyo (JP); Seishi TAKAMURA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 17/774,058

(22) PCT Filed: Nov. 15, 2019
(86) PCT No.: PCT/JP2019/044862

§ 371 Date: May 3, 2022

(51) Int. Cl. G06T 9/00; G06T 3/40

(52) U.S. Cl. CPC G06T 9/00; G06T 3/40

(57) ABSTRACT

A decoding apparatus includes: an obtainment unit in which a high frame rate, a medium frame rate, and a low frame rate have been determined in advance in descending order of frame rate, and which obtains low-frame-rate images that are moving images with the low frame rate, as well as weights; and a decoding unit that generates a third frame of medium-frame-rate images that are moving images with the medium frame rate by compositing a first frame and a second frame that are chronologically contiguous in the low-frame-rate images based on the weights. The low-frame-rate images and the weights are derived in advance so as to minimize a degree of deviation between a plurality of frames of moving images with the high frame rate in a preset period and a plurality of frames of the medium-frame-rate images in the period.

### TECHNICAL FIELD

The present invention relates to a decoding apparatus, an encoding apparatus, a decoding method, an encoding method, and a program.

### BACKGROUND ART

The recent advancement in semiconductor technology has significantly improved the frame rate of moving images on a high-speed camera. The intentions of high-frame-rate images obtained by a high-speed camera are categorized into achievement of high image quality at the time of image reproduction, and achievement of high accuracy in image analysis.

Achievement of high image quality at the time of image reproduction aims to present smooth movements of a subject by getting close to the upper limit of frame rates that can be detected by a visual system (can be displayed on a display). Therefore, achievement of high image quality at the time of image reproduction is based on the premise that a display apparatus reproduces moving images at a constant speed.

On the other hand, achievement of high accuracy in image analysis aims to increase the accuracy of image analysis by using high-frame-rate-images that exceed the visual perceptible limit. Typical application examples include image analysis of high-speed moving objects, such as athletes, FA examinations, and automobiles, during slow-motion reproduction.

The upper limit of frame rates of a moving image input system and the upper limit of frame rates of a moving image output system are asymmetric. That is to say, the upper limit of frame rates of a high-speed camera, which is a moving image input system, exceeds 10000 fps. On the other hand, the upper limit of frame rates of a display apparatus, which is a moving image output system, ranges from 120 fps to 240 fps. Therefore, moving images shot by the high-speed camera are used in slow-motion reproduction (see PTL 1).

### CITATION LIST

### Patent Literature

[PTL 1] Japanese Patent Application Publication No. 2004-201165

### SUMMARY OF THE INVENTION

### Technical Problem

The use of high-frame-rate images that exceed the visual perceptible limit makes it possible to generate images for constant-speed reproduction, which has a high affinity for encoding processing of moving images. High-frame-rate images include a frame group that has been sampled at high density in the time direction. An image generation apparatus can control the generation of images for constant-speed reproduction with a high temporal resolution by generating images for constant-speed reproduction of 30 Hz and the like with use of a frame group that has undergone high-density temporal sampling of 1000 Hz and the like.

However, preprocessing for moving image encoding, which aims to reduce the amount of generated codes, is based on the premise that an image generation apparatus samples frames at a reproduction frame rate. Therefore, conventional image generation apparatuses do not sample frames with a temporal resolution higher than a reproduction frame rate.

In processing for simply thinning out the frames of high-frame-rate images, deterioration in image quality attributed to aliasing in the time direction becomes a problem. In order to avoid such a problem, band limiting filtering in the time axis direction using a temporal filter is necessary.

On the other hand, in an encoder that uses motion compensation inter-frame prediction, a reduction in aliasing in the time direction has no direct relationship with a reduction in prediction error. Also, in an encoder that uses motion compensation inter-frame prediction, frames that have undergone high-density temporal sampling are not sufficiently utilized, and the degree of freedom as a temporal filter is limited.

That is to say, in the case of moving images with a low frame rate of, for example, 30 fps or 60 fps (hereinafter referred to as “low-frame-rate images”), a sufficient number of samples (frames) for filtering cannot be secured, and it is thus difficult to bring the filter characteristics close to high accuracy. For example, in the case where moving image signals of 30 fps are generated from moving image signals of 60 fps by filtering the moving image signals of 60 fps, there is a constraint that frames to be filtered are limited to 2 (=60/30) frames under the condition that there is no overlap in frames to be filtered.

On the other hand, in the case of high-frame-rate images, the degree of freedom in filter design is expanded. For example, in a case where moving image signals of 62.5 fps are generated from moving image signals of 1000 fps by filtering the moving image signals of 1000 fps, the number of frames to be filtered can be 16 frames (=1000/62.5), which is more than 2 frames, even under the condition that there is no overlap in frames to be filtered. As such, in the case where low-frame-rate images are generated from high-frame-rate images, the degree of freedom in filtering design is high. Utilizing such a high degree of freedom gives rise to the possibility that an encoder can improve the encoding efficiency.

In the first place, according to conventional technology, attention has been drawn to the generation of low-frame-rate moving images based on high-frame-rate moving images on a decoding apparatus. However, there could also be a case where an encoding apparatus generates low-frame-rate moving images, which make it easy to generate medium-frame-rate moving images on a decoding apparatus, based on high-frame-rate moving images. Here, easy to generate refers to suppression of deterioration in subjective image quality and improvements in the encoding efficiency.

However, there is a case where conventional apparatuses cannot select a coefficient of a temporal filter that improves the encoding efficiency of low-frame-rate images that are generated from high-frame-rate images.

With the foregoing issue in view, it is an object of the present invention to provide a decoding apparatus, an encoding apparatus, a decoding method, an encoding method, and a program that can select a coefficient of a temporal filter that improves the encoding efficiency of low-frame-rate images that are generated from high-frame-rate images.

### Means for Solving the Problem

An aspect of the present invention is a decoding apparatus including: an obtainment unit in which a high frame rate, a medium frame rate, and a low frame rate have been determined in advance in descending order of frame rate, and which obtains low-frame-rate images that are moving images with the low frame rate, as well as weights; and a decoding unit that generates a third frame of medium-frame-rate images that are moving images with the medium frame rate by compositing a first frame and a second frame that are chronologically contiguous in the low-frame-rate images based on the weights, wherein the low-frame-rate images and the weights are derived in advance so as to minimize a degree of deviation between a plurality of frames of moving images with the high frame rate in a preset period and a plurality of frames of the medium-frame-rate images in the period.

### Effects of the Invention

The present invention enables selection of a coefficient of a temporal filter that improves the encoding efficiency of low-frame-rate images that are generated from high-frame-rate images.

### BRIEF DESCRIPTION OF DRAWINGS

FIG. 1 is a diagram showing an exemplary configuration of a filtering system in an embodiment.

FIG. 2 is a diagram showing an exemplary hardware configuration of the filtering system in the embodiment.

FIG. 3 is a diagram showing the examples of the amount of deviation, the degree of deviation, and the amount of generated codes in the embodiment.

FIG. 4 is a diagram showing an example of selection of a coefficient candidate vector in the embodiment.

FIG. 5 is a flowchart showing the exemplary operations of an encoding apparatus in the embodiment.

FIG. 6 is a flowchart showing the exemplary operations of a decoding apparatus in the embodiment.

### DESCRIPTION OF EMBODIMENTS

An embodiment of the present invention will be described in detail with reference to the drawings.

Below, a high frame rate, a medium frame rate, and a low frame rate have been set in advance in descending order of frame rate (temporal resolution). The high frame rate is, for example, 1000 fps. The medium frame rate is, for example, 240 fps. The low frame rate is, for example, 30 fps or 60 fps.

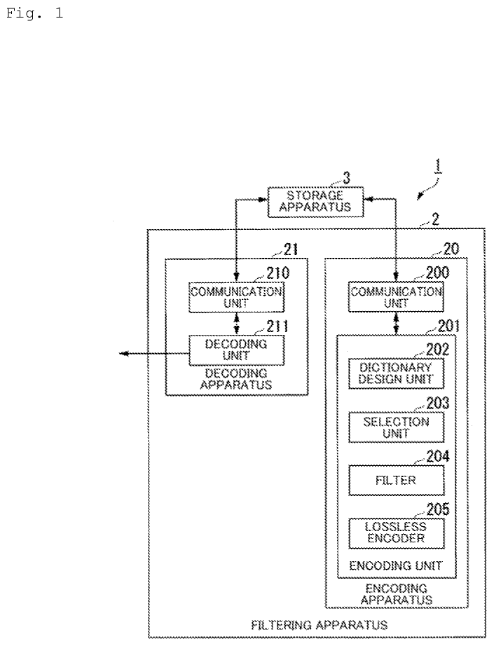

FIG. 1 is a diagram showing an exemplary configuration of a filtering system 1. The filtering system 1 is a system that executes temporal filtering with respect to high-frame-rate moving images (hereinafter referred to as “high-frame-rate images”). The filtering system 1 includes a filtering apparatus 2 and a storage apparatus 3.

The filtering apparatus 2 is an apparatus that executes temporal filtering with respect to high-frame-rate images. The filtering apparatus 2 includes an encoding apparatus 20 and a decoding apparatus 21. Note that it is sufficient for the encoding apparatus 20 to include at least one of the functional components of the decoding apparatus 21. It is sufficient for the decoding apparatus 21 to include at least one of the functional components of the encoding apparatus 20.

The encoding apparatus 20 includes a communication unit 200 and an encoding unit 201. The encoding unit 201 includes a dictionary design unit 202, a selection unit 203, a filter 204, and a lossless encoder 205. The decoding apparatus 21 includes a communication unit 210 and a decoding unit 211.

The storage apparatus 3 stores, for example, a frame group of high-frame-rate images before filtering processing, a frame group of low-frame-rate images after filtering processing, weights allocated to frames of low-frame-rate images, a data table, and a program. The data table represents, for example, a dictionary of candidates for filter coefficients.

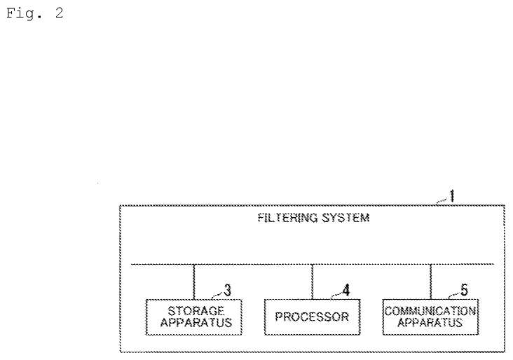

FIG. 2 is a diagram showing an exemplary hardware configuration of the filtering system 1. The filtering system 1 includes the storage apparatus 3, a processor 4, and a communication apparatus 5.

A part or all of the communication unit 200, encoding unit 201, communication unit 210, and decoding unit 211 are realized as software by the processor 4, such as a CPU (Central Processing Unit), executing the program stored in the storage apparatus 3, which includes a nonvolatile recording medium (non-temporary recording medium). The program may be recorded in a computer-readable recording medium. The computer-readable recording medium is, for instance, a non-temporary recording medium, examples of which include a flexible disk, a magneto-optical disc, a ROM (Read Only Memory), a portable medium such as a CD-ROM (Compact Disc Read Only Memory), and a storage apparatus built in a computer system such as a hard disk. One or both of the communication unit 200 and communication unit 210 may be included in the communication apparatus 5. The program may be received by the communication apparatus 5 via an electronic telecommunication line.

A part or all of the communication unit 200, encoding unit 201, communication unit 210, and decoding unit 211 may be realized using, for example, hardware including an electronic circuit or circuitry that uses an LSI (Large Scale Integration circuit), an ASIC (Application Specific Integrated Circuit), a PLD (Programmable Logic Device), an FPGA (Field Programmable Gate Array), or the like.

The communication unit 200 obtains high-frame-rate images from the storage apparatus 3. The communication unit 200 obtains, from the lossless encoder 205, the result of encoding of low-frame-rate images that have been generated by the filter 204 based on the high-frame-rate images. The communication unit 200 records the result of encoding of the low-frame-rate images into the storage apparatus 3. The communication unit 200 records the weights that have been allocated to respective frames of the low-frame-rate images by the selection unit 203 into the storage apparatus 3.

The dictionary design unit 202 designs a dictionary (a collection of candidate vectors of filter coefficients) so that, in a case where the candidate vector of the optimum filter coefficient has been selected from the dictionary, the filter design cost is minimized when the optimum shift amount has been derived in accordance with the selected candidate vector.

Below, a frame of an image input to a temporal filter is referred to as an “original frame”. A frame of an image output from the temporal filter is referred to as a “composite frame”.

The selection unit 203 derives the amount of deviation between a plurality of original frames in high-frame-rate images during a preset period and a plurality of frames (composite frames) in low-frame-rate images during the same period.

The selection unit 203 derives the degree of deviation between a plurality of original frames in high-frame-rate images during a preset period and a plurality of frames (display frames) in moving images with a medium frame rate (hereinafter referred to as “medium-frame-rate images) during the same period.

The selection unit 203 selects, from the dictionary (the collection of candidate vectors of filter coefficients), a filter coefficient that minimizes the filter design cost determined by the derived degree of deviation. The selection unit 203 selects a shift amount that minimizes the cost determined by the derived degree of deviation as a shift amount of the filter position.

The selection unit 203 may select, from the dictionary, a filter coefficient that minimizes the filter design cost determined by the amount of generated codes of the plurality of frames in the low-frame-rate images during the same preset period, and by the derived degree of deviation.

The selection unit 203 may select, from the dictionary, a filter coefficient that minimizes the filter design cost determined by the amount of generated codes of frames to be encoded in the low-frame-rate images during the same preset period, and by the derived degree of deviation.

Note that the selection unit 203 may generate a third frame (display frame) in the medium-frame-rate images by compositing a first frame and a second frame (frames to be encoded) that are chronologically contiguous in the low-frame-rate images based on weights.

Using a plurality of frames of the high-frame-rate images, the filter 204 generates a plurality of composite frames (frames to be encoded) in the low-frame-rate images in accordance with the selected filter coefficient. The lossless encoder 205 executes lossless encoding with respect to the plurality of composite frames in the low-frame-rate image.

The communication unit 210 (obtainment unit) obtains low-frame-rate images and weights from the storage apparatus 3. The decoding unit 211 generates a third frame (display frame) in medium-frame-rate images by compositing a first frame and a second frame (frames to be encoded) that are chronologically contiguous in the low-frame-rate images based on weights.

Next, the details of the filtering system 1 will be described.

### <Regarding Method of Notation>

The communication unit 200 obtains high-frame-rate images from the storage apparatus 3. The encoding unit 201 designs a temporal filter for generating low-frame-rate images from high-frame-rate images. Due to a small amount of generated codes, low-frame-rate images are moving images appropriate for encoding. Also, low-frame-rate images are moving images appropriate for the encoding standards.

Below, for the sake of simplified notation, each frame of moving images is described as a one-dimensional signal. An original frame is sampled at a temporal position t (t=jₛδₛ (jₛ=0, 1, . . . ) ). δₛ denotes an interval between frames of moving images input to the temporal filter. Below, a section (period) “iMδₛ≤t≤((i+1)M−1)δₛ” along the time axis is referred to as the “i^{th} stage”.

The filter 204 is a (2Δ+1)-tap temporal filter. The i^{th} frame output from the filter 204 in the i^{th} stage is denoted by expression (1).

$$\begin{matrix}[ Math . 1 ] & \\ f ( x , i , M , {w}_{i} , {p}_{i} ) = {\sum }_{{j}_{s} = - Δ}^{Δ} {w}_{i} [ {j}_{s} ] f ( x , i M + ⌊ \frac{M}{2} ⌋ + {p}_{i} + {j}_{s} ) & ( 1 )\end{matrix}$$

i denotes an index that designates a stage. The value of i is a non-negative integer value. f(x, jₛ) denotes a pixel value at the position x (x=0, . . . , x−1) of the jₛ^{th} original frame. The function expression (2) indicated by expression (1) denotes the maximum integer that does not exceed (M/2), with use of a floor function.

$$\begin{matrix}[ Math . 2 ] & \\ ⌊ \frac{M}{2} ⌋ & ( 2 )\end{matrix}$$

wᵢ[jₛ] denotes a filter coefficient of the temporal filter. Here, expression (3) is satisfied.

$$\begin{matrix}[ Math . 3 ] & \\ {\sum }_{{j}_{s} = - Δ}^{Δ} {w}_{i} [ {j}_{s} ] = 1 & ( 3 )\end{matrix}$$

wᵢ (=(wᵢ[−Δ], . . . , wᵢ[Δ]) denotes a vector that has a filter coefficient as an element (hereinafter referred to as a “coefficient vector”). pᵢ denotes a parameter that controls a shift amount at a filter position. That is to say, pᵢ denotes a parameter that corrects a temporal position at which a filter coefficient is applied. The value of pᵢ is (0, . . . ±P).

“M” is a parameter that determines a frame interval of composite frames. In a case where the shift amount has a zero value in expression (1), the frame interval of composite frames is denoted by “Mδₛ”. Below, (2Δ+2P+1≤M) is satisfied. Hereinafter, a candidate for a coefficient vector is referred to as a “coefficient candidate vector”.

A dictionary composed of N types of coefficient candidate vectors (a collection of coefficient candidate vectors) is denoted by “Γ_{N}=(γ₀, . . . , γ_{N-1})”. Here, γₙ (=(γₙ[−Δ], . . . , γₙ[Δ]) denotes the n^{th} coefficient candidate vector (n=0, . . . , N−1).

<Regarding Formulization of Designing of Filter 204 (Temporal Filter)>

### [Regarding Standards of Optimization of Filter Coefficient and Shift Amount]

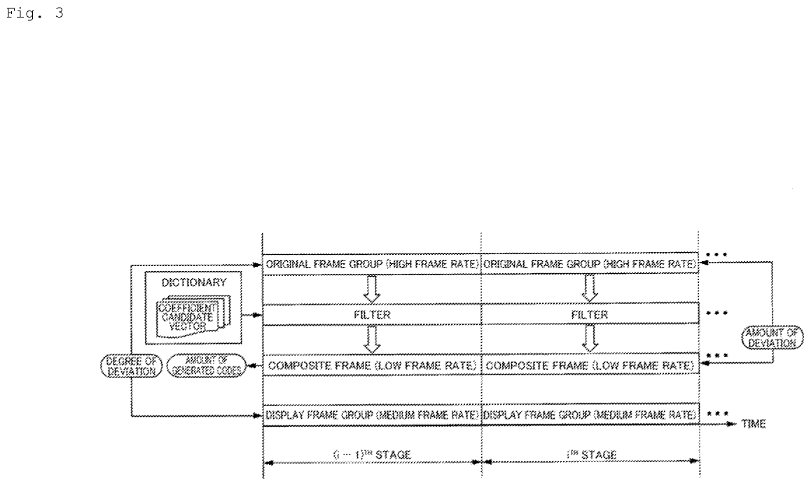

FIG. 3 is a diagram showing the examples of the amount of deviation, the degree of deviation, and the amount of generated codes. The selection unit 203 selects a coefficient vector and a shift amount based on the amount of deviation between composite frames and original frames in the same stage (period).

The selection unit 203 may select a coefficient vector and a shift amount based on the amount of generated codes of composite frames and on the degree of deviation between display frames and original frames in the same stage (period). The amount of generated codes is the amount of codes for the output of the lossless encoder 205 that executes lossless encoding with respect to composite frames.

Based on the selected coefficient vector and shift amount, the filter 204 executes processing of the temporal filter with respect to an original frame group with a high frame rate. As a result of the execution of the processing of the temporal filter, the filter 204 generates a composite frame group with a low frame rate. The filter 204 outputs the composite frame group to the lossless encoder 205.

The lossless encoder 205 obtains the composite frame group as a frame group to be encoded through lossless encoding. The lossless encoder 205 executes motion compensation prediction with respect to the composite frame group. In the motion compensation prediction, the lossless encoder 205 divides a frame to be encoded into partial regions. For each of the partial regions in a frame to be encoded (a predicted frame), the lossless encoder 205 derives a corresponding region in a reference frame included among the composite frame group. The lossless encoder 205 encodes a frame to be encoded based on the difference (prediction error) between the partial regions of the frame to be encoded and the corresponding regions of the reference frame.

Below, a symbol (e.g., \hat{ }) that is placed above a character in mathematical expressions is provided immediately before that character. A frame to be encoded (the i^{th} composite frame) is denoted by “\hat{ }f(x, i, M, wᵢ, pᵢ)”. “wᵢ” denotes a coefficient vector of the i^{th} composite frame. “pᵢ” denotes the shift amount of the i^{th} composite frame.

In a case where (i≥1) is satisfied, the lossless encoder 205 executes encoding of motion compensation prediction that uses the reference frame (inter-frame prediction) with respect to the i^{th} composite frame. The reference frame (the (i−1)^{th} composite frame) is denoted by “\hat{ }f(x, i−1, M, wᵢ₋₁, pᵢ₋₁)”. “wᵢ₋₁” denotes a coefficient vector of the (i−1)^{th} composite frame. “pᵢ₋₁” denotes the shift amount of the (i−1)^{th} composite frame. The amount of generated codes of the frame to be encoded is denoted by “Ψ[wᵢ, wᵢ₋₁, pᵢ, pᵢ₋₁ ]”.

When (i=0) is satisfied, the lossless encoder 205 executes intra-frame encoding with respect to the 0^{th} composite frame. The amount of generated codes of the frame to be encoded is denoted by “Ψ[w₀, w₋₁, p₀, p₋₁]”. “w₀” denotes a coefficient vector of the 0^{th} composite frame. “w₋₁” is a variable that does not have a value (a dummy variable). “p₀” denotes the shift amount of the 0^{th} composite frame.

“p₋₁” is a variable that does not have a value (a dummy variable).

The amount of deviation between composite frames and original frames in the same stage (period) is denoted by expression (4).

$$\begin{matrix}[ Math . 4 ] & \\ Φ [ {w}_{i} , {p}_{i} ] = {\sum }_{k = ⌊ \frac{M}{2} ⌋}^{M + ⌊ \frac{M}{2} ⌋ - 1} {\sum }_{x = 0}^{X - 1} {\{ f ( x , iM + k ) - \hat{f} ( x , i , M , {w}_{i} , {p}_{i} ) \}}^{2} & ( 4 )\end{matrix}$$

Expression (4) indicates a sum of squared differences between composite frames and original frames in the i^{th} stage (i^{th} period). “X” denotes the number of pixels in a composite frame or an original frame. In designing of the filter 204, the selection unit 203 minimizes the amount of generated codes, as indicated by expression (5), under the constraint condition that the amount of deviation is brought to a predetermined threshold or less.

$$\begin{matrix}[ Math . 5 ] & \\ min {{\sum }_{i = 0}}^{J / M - 1} Ψ [ {w}_{i} , {w}_{i - 1} , {p}_{i} , {p}_{i - 1} ] , & ( 5 )\end{matrix}$$

$$subject to {{\sum }_{i = 0}}^{J / M - 1} Φ [ {w}_{i} , {p}_{i} ] \leq {D}_{0}$$

The selection unit 203 solves the minimization problem with the constraint condition indicated by expression (5) as a minimization problem with no constraint for a cost function (filter design cost) indicated by expression (6).

[Math. 6]

Ξ[wᵢ,wᵢ₋₁,pᵢ,pᵢ₋₁]=Ψ[wᵢ,wᵢ₋₁,pᵢ,pᵢ₋₁]+λΦ[wᵢ,pᵢ] (6)

Here, “2” denotes a control parameter for satisfying the constraint condition in expression (5).

[Regarding Optimization of Design of Temporal Filter]

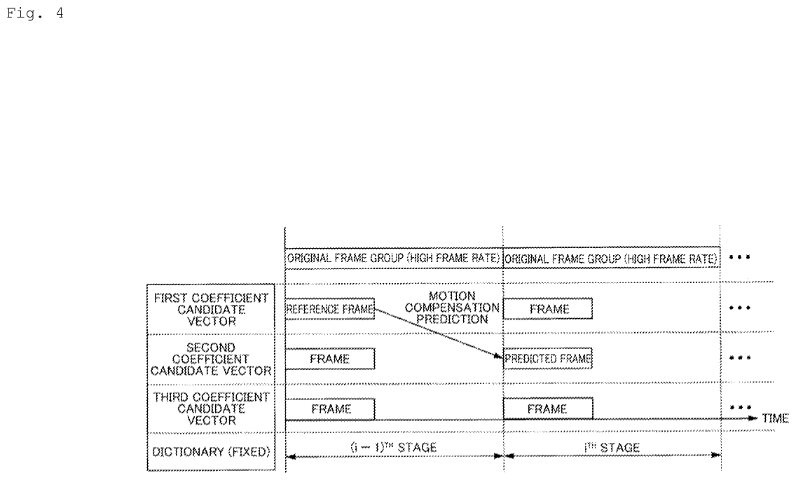

FIG. 4 is a diagram showing an example of selection of a coefficient candidate vector. In optimization of the design of the temporal filter, the dictionary design unit 202 determines a candidate for a coefficient vector to be registered in the dictionary based on Bayesian optimization. In this way, the dictionary design unit 202 can design the dictionary.

For each composite frame, the selection unit 203 selects a coefficient vector based on dynamic programming from among the candidates for coefficient vectors registered with the dictionary. Based on the selected coefficient vector, the selection unit 203 derives a shift amount for each composite frame based on dynamic programming. A path connecting between a reference frame and a predicted frame (a shift amount) indicates the value of the evaluation scale (cost).

[Regarding Optimization of Filter Coefficient (Coefficient Vector) to be Registered with Dictionary and Shift Amount]

In order for the filter 204 to generate a composite frame that minimizes the sum of the filter design costs (evaluation scales) indicated by expression (6), the selection unit 203 derives the solution of the minimization problem indicated by expression (7) with respect to (J/M) combinations of coefficient vectors and shift amounts.

$$\begin{matrix}[ Math . 7 ] & \\ ( {w}_{0}^{*} , … , {w}_{J / M - 1}^{*} , {p}_{0}^{*} , … {p}_{J / M - 1}^{*} ) = {{arg min}_{{w}_{0} , … , {w}_{J / M - 1} ∈ {Γ}_{n}}}_{{p}_{0} , … , {p}_{J / M - 1}} {{\sum }_{i = 0}}^{J / M - 1} Ξ [ {w}_{i} , {w}_{i - 1} , {p}_{i} , {p}_{i - 1} ] & ( 7 )\end{matrix}$$

In a case where the selection unit 203 derives the solution of the minimization problem indicated by expression (7) with use of a brute-force method, a computation amount of an exponential order is required. In contrast, in a case where the selection unit 203 derives the solution of the minimization problem indicated by expression (7) based on dynamic programming, a computation amount of a polynomial order is required. Thus, the selection unit 203 derives the solution of the minimization problem indicated by expression (7) based on dynamic programming. An evaluation scale “Sᵢ(wᵢ, pᵢ)” is denoted by expression (8).

$$\begin{matrix}[ Math . 8 ] & \\ {S}_{l} ( {w}_{i} , {p}_{i} ) = {{min}_{{w}_{0} , … , {w}_{J / M - 1} ∈ {Γ}_{n}}}_{{p}_{0} , … , {p}_{J / M - 1}} {\sum }_{j = 1}^{i} Ξ [ {w}_{i} , {w}_{i - 1} , {p}_{i} , {p}_{i - 1} ] & ( 8 )\end{matrix}$$

The evaluation scale “Sᵢ(wᵢ, pᵢ)” satisfies a recurrence formula indicated by expression (9).

$$\begin{matrix}[ Math . 9 ] & \\ {S}_{l} ( {w}_{i} , {p}_{i} ) = {{min}_{{w}_{i - 1} ∈ {Γ}_{n}}}_{{p}_{i - 1}} \{ Ξ [ {w}_{i} , {w}_{i - 1} , {p}_{i} , {p}_{i - 1} ] + {S}_{i - 1} ( {w}_{i - 1} , {p}_{i - 1} ) \} & ( 9 )\end{matrix}$$

As indicated by expression (9), the selection unit 203 derives the evaluation scale “Sᵢ(wᵢ, pᵢ)” by deriving a shift amount “pᵢ” with the selection of the coefficient candidate vector that minimizes “Ξ[wᵢ, wᵢ₋₁, pᵢ, pᵢ₋₁]+Sᵢ₋₁(wᵢ₋₁, pᵢ₋₁)”. As a result, the problem that derives the solution of the minimization problem indicated by expression (7) becomes the problem that searches for the optimum solution for “{N×(2P+1)}²J/M” combinations of coefficient vectors and shift amounts. The selection unit 203 selects the optimum filter coefficient and shift amount under the condition in which the dictionary designed by the dictionary design unit 202 has been given.

[Regarding Designing of Dictionary]

The dictionary Γ has N types of coefficient candidate vectors. A coefficient candidate vector has (2Δ+1) elements. Therefore, the dictionary Γ is a collection of the values of “(2Δ+1)N” real numbers. An evaluation scale of the design of the dictionary is a filter design cost of a case where the optimum shift amount has been derived in accordance with the optimum coefficient vector that has been selected from the dictionary. Hereinafter, this cost is referred to as a “fixed dictionary optimum cost”. The fixed dictionary optimum cost is denoted by expression (10).

$$\begin{matrix}[ Math . 10 ] & \\ Ω ( Γ ) = {{min}_{{w}_{0} , … , {w}_{J / M - 1} ∈ Γ}}_{{p}_{0} , … , {p}_{J / M - 1}} {\sum }_{j = 1}^{J / M - 1} Ξ [ {w}_{i} , {w}_{i - 1} , {p}_{i} , {p}_{i - 1} ] & ( 10 )\end{matrix}$$

The dictionary design unit 202 estimates a collection of coefficient candidate vectors that minimizes the fixed dictionary optimum cost. That is to say, the dictionary design unit 202 searches for the minimum value of evaluation scales (fixed dictionary optimum costs) in the “(2Δ+1)N”-dimensional space. However, a fixed dictionary optimum cost is an indifferentiable non-linear function, and an indifferentiable non-convex function. Therefore, the dictionary design unit 202 cannot analytically derive the minimum value. Also, the dictionary design unit 202 cannot derive the minimum value based on convex optimization.

In view of this, the dictionary design unit 202 derives the minimum value of fixed dictionary optimum costs based on Bayesian optimization. That is to say, the dictionary design unit 202 estimates the relationship between fixed dictionary optimum costs and the dictionary based on Bayesian optimization. In this way, the dictionary design unit 202 can design the optimum dictionary that minimizes the fixed dictionary optimum cost.

In a case where a high computation cost is required for the derivation of an evaluation scale, Bayesian optimization is a method suited for a multidimensional search based on the result of observation of limited sample points. This is because, in Bayesian optimization, the value of an evaluation scale is estimated with respect to unobserved sample points based on Bayesian estimation in a Gaussian process.

In a case where the dictionary design unit 202 estimates a fixed dictionary optimum cost corresponding to the dictionary, an observation model indicated by expression (11) is used in Bayesian optimization.

$$\begin{matrix}[ Math . 11 ] & \\ {Ω}_{i} = h ( {Γ}_{i} ) + {ϵ}_{i} , {ϵ}_{i} {∼}^{iid} 𝒩 ( 0 , {ρ}^{2} ) & ( 11 )\end{matrix}$$

Here, “Γᵢ” denotes the i^{th} coefficient vector in the dictionary. “h” denotes an unknown function. “Ωᵢ” denotes a cost function (filter design cost) corresponding to the i^{th} coefficient vector in the dictionary. “εᵢ” denotes noise at the time of observation. “N(0,2)” denotes a Gaussian distribution with a mean of 0 and a deviation of 2.

Hereinafter, “{h(Γ₁), . . . , h(Γₘ)} is abbreviated as “h_{1:m}”. “{Γ₁, . . . , Γₘ}” is abbreviated as “Γ_{1:m}”. “{Ω₁, . . . , Ωₘ}” is abbreviated as “Ω_{1:m}”.

The target of estimation in Bayesian optimization is an unknown function “h”. The dictionary design unit 202 estimates the unknown function “h” with use of the Gaussian process as a prior distribution. That is to say, the dictionary design unit 202 estimates the collection of function values “h_{1:m}” with use of the multidimensional Gaussian distribution “N(0, K(Γ_{1:m})”. Here, “K(Γ_{1:m})” is an “m×m” matrix. The (i,j)^{th} element of “K(Γ_{1:m})” is a covariance function k (Γᵢ, Γⱼ).

The dictionary design unit 202 uses the “Matern 5/2 kernel” as the covariance function. Expression (11) is an observation value model in which noise “εᵢ” is superimposed on the unknown function “h” with respect to the i^{th} coefficient vector “Γᵢ”.

In Bayesian optimization, the dictionary design unit 202 selects a search point that is expected to minimize observation values, sequentially from among the plurality of coefficient vectors in the dictionary. The dictionary design unit 202 accumulates the observation values “D_{1:m}={Γ_{1:m}, Ω_{1:m}}. The dictionary design unit 202 derives a posterior distribution of the unknown function “h” based on the Bayes' rule. Using the posterior distribution of the unknown function “h”, the dictionary design unit 202 analytically derives a Bayesian prediction distribution of the observation value “Ω” of the unknown sample “Γ” as indicated by expression (12).

[Math. 12]

p(Ω|Γ; [symbol] _{1:m})= [symbol] (Γ; [symbol] _{1:m}),σₘ²(Γ; [symbol] _{1:m}))

μₘ(Γ; [symbol] _{1:m})=k(Γ)^{T}(K(Γ_{1:m})+ρ²I)⁻¹Ω_{1:m}

σₘ²(Γ; [symbol] _{1:m})=k(Γ,Γ)−k(Γ)^{T}(K(Γ_{1:m})+ρ²I)⁻¹k(Γ) (12)

Here, “k (Γ)” denotes “(k (Γ, Γ₁), . . . , k(Γ, Γm))^{T}”. “Ω_{1:m}” denotes “(Ω₁, . . . , Ω_{M})^{T}”. “T” denotes a transposition. “I” denotes a unit matrix of (m×m).

Based on the Bayesian prediction distribution, the dictionary design unit 202 derives an evaluation scale (the value of the acquisition function) with respect to the selected search point. That is to say, based on the Bayesian prediction distribution, the dictionary design unit 202 derives a fixed dictionary optimum cost with respect to the selected search point. The dictionary design unit 202 selects the next search point so as to minimize the derived evaluation scale (fixed dictionary optimum cost). Below, as one example, a lower confidence bound is used as the value of the acquisition function.

<Regarding Adaptive Settings of Weights for Display Frames>

Below, “Mₛ” denotes the number of original frames per stage, which is a section (period) along the time axis. “M_{d}” denotes the number of display frames per stage, which is a section (period) along the time axis. “R_{d}=Mₛ/M_{d}” denotes the number of original frames per display frame.

A display frame group in a section “(iMₛ+i_{d}R_{d})δₛ≤t≤(iMₛ+(i_{d}+1) R_{d}−1)δₛ” along the time axis is denoted by expression (13). That is to say, the i_{d}^{th} (=0, . . . , M_{d}−1) display frame in the i^{th} stage is denoted by expression (13). The frame rate of the display frame group (medium frame rate) is higher than the low frame rate, and lower than the high frame rate.

$$\begin{matrix}[ Math . 13 ] & \\ g ( {iM}_{d} + {i}_{d} , {α}_{{i}_{d}} ) = \{ \begin{matrix}{α}_{{i}_{d}} \hat{f} ( i - 1 , {M}_{s} , {w}_{i - 1} , {p}_{i - 1} ) + ( 1 - {α}_{{i}_{d}} ) \hat{f} ( i , {M}_{s} , {w}_{i} , {p}_{i} ) \\ ( in case where {i}_{d} = 0 , … , ⌊ {M}_{d} / 2 ⌋ - 1 ) \\ {α}_{{i}_{d}} \hat{f} ( i - 1 , {M}_{s} , {w}_{i} , {p}_{i} ) + ( 1 - {α}_{{i}_{d}} ) \hat{f} ( i + 1 , {M}_{s} , {w}_{i + 1} , {p}_{i + 1} ) \\ ( in case where {i}_{d} = ⌊ {M}_{d} / 2 ⌋ , … , {M}_{d} - 1 )\end{matrix} & ( 13 )\end{matrix}$$

Note that when the number of composite frames (frames to be encoded) is equal to the number of display frames, “M_{d}” is 1, and thus the display frame group is denoted by expression (14). In expression (14), the frame rate of the display frame group (medium frame rate) is equal to the low frame rate, and lower than the high frame rate.

[Math. 14]

g(i,αᵢ_{_{d}})=\hat{f}(i,Mₛ,wᵢ,pᵢ) (14)

The degree of deviation between display frames and original frames in the i^{th} stage is denoted by expression (15)

$$\begin{matrix}[ Math . 15 ] & \\ {Φ}_{d} ( {α}_{i} , {w}_{i - 1 : i + 1} , {p}_{i - 1 : j + 1} ) = {\sum }_{{i}_{d} = 0}^{{M}_{d} - 1} {\sum }_{{j}^{′} = 0}^{{R}_{d} - 1} {‖ f ( {iM}_{s} + {i}_{d} {R}_{d} + {j}^{′} ) - g ( {iM}_{d} + {i}_{d} , {α}_{{i}_{d}} ) ‖}_{F}^{2} & ( 15 )\end{matrix}$$

Here, “αᵢ” denotes “(α₀, . . . , α_{Md-1})”. “w_{i-1:i+1}” denotes “wᵢ₋₁, wᵢ, wᵢ₊₁)”. “p_{i-1:i+1}” denotes “pᵢ₋₁, pᵢ, pᵢ₊₁)”.

The selection unit 203 determines weights with use of, for example, one of a first setting method to a third setting method.

The first setting method is denoted by expression (16).

$$\begin{matrix}[ Math . 16 ] & \\ {α}_{i}^{*} , {arg min}_{{α}_{0} , … , {α}_{{M}_{d} - 1}} {Φ}_{d} ( {α}_{i} , {w}_{i - 1 : i + 1} , {p}_{i - 1 : i + 1} ) & ( 16 )\end{matrix}$$

The second setting method is denoted by expression (17).

$$\begin{matrix}[ Math . 17 ] & \\ {α}_{i}^{*} , {w}_{i - 1 : i + 1}^{*} , {p}_{i - 1 : i + 1}^{*} = {arg min}_{{α}_{0} , … , {α}_{{M}_{d} - 1}} {Ξ}_{d} [ {α}_{i} , {w}_{i - 1 : i + 1} , {p}_{i - 1 : i + 1} ] & ( 17 )\end{matrix}$$

Here, “Ξ_{d}” is denoted by expression (18) as a cost function obtained by correcting the cost function (filter design cost) indicated by expression (6).

$$\begin{matrix}[ Math . 18 ] & \\ {Ξ}_{d} [ {α}_{i} , {w}_{i - 1 : i + 1} , {p}_{i - 1 : i + 1} ] = Ψ [ {w}_{i} , {w}_{i - 1} , {p}_{i} , {p}_{i - 1} ] + λ {Φ}_{d} ( {α}_{i} , {w}_{i - 1 : i + 1} , {p}_{i - 1 : i + 1} ) & ( 18 )\end{matrix}$$

The third setting method is denoted by expression (19).

$$\begin{matrix}[ Math . 19 ] & \\ {α}_{i}^{*} , {w}_{i - 1 : i + 1}^{*} , {p}_{i - 1 : j + 1}^{*} {arg min}_{{α}_{0} , … , {α}_{{M}_{d} - 1}} {Ξ}_{d}^{′} [ {α}_{i} , {w}_{i - 1 : i + 1} , {p}_{i - 1 : i + 1} ] & ( 19 )\end{matrix}$$

Here, “Ξ′_{d}” is denoted by expression (20) as a cost function obtained by correcting the cost function (filter design cost) indicated by expression (6).

$$\begin{matrix}[ Math . 20 ] & \\ {Ξ}_{d}^{′} [ {α}_{i} , {w}_{i - 1 : i + 1} , {p}_{i - 1 : i + 1} ] = Ψ [ {w}_{i} , {w}_{i - 1} , {p}_{i} , {p}_{i - 1} ] + ψ ( {α}_{i} ) + λ {Φ}_{d} ( {α}_{i} , {w}_{i - 1 : i + 1} , {p}_{i - 1 : i + 1} ) & ( 20 )\end{matrix}$$

Here, ψ(αᵢ) denotes the amount of codes for the weight “αᵢ”.

Next, the exemplary operations of the filtering system 1 will be described.

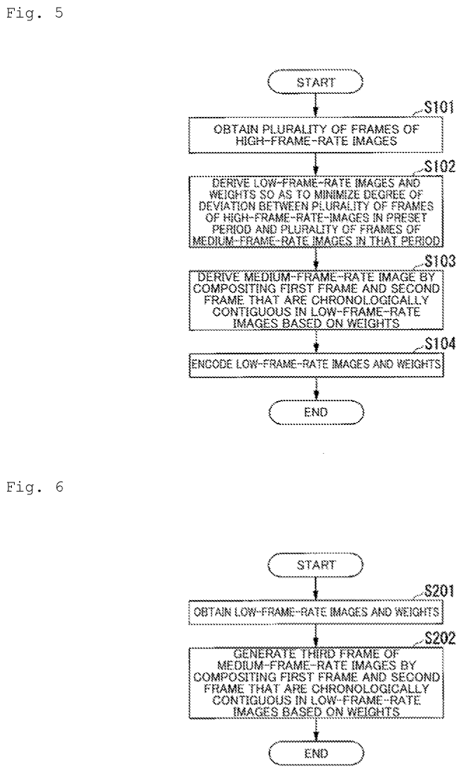

FIG. 5 is a flowchart showing the exemplary operations of the encoding apparatus 20. The communication unit 200 obtains a plurality of frames of high-frame-rate images (an original frame group) from the storage apparatus 3 (step S101). The encoding unit 201 derives low-frame-rate images and weights so as to minimize the degree of deviation between a plurality of frames of high-frame-rate images in a preset period and a plurality of frames of medium-frame-rate images in that period (step S102).

The encoding unit 201 derives a medium-frame-rage image by compositing a first frame and a second frame that are chronologically contiguous in low-frame-rate images based on weights (step S103). The encoding unit 201 encodes the low-frame-rate images and weights (step S104).

FIG. 6 is a flowchart showing the exemplary operations of the decoding apparatus 21. The communication unit 210 obtains low-frame-rate images and weights from the storage apparatus 3 (step S201). The decoding unit 211 generates a third frame (display frame) of medium-frame-rate images by compositing a first frame and a second frame that are chronologically contiguous in low-frame-rate images based on weights (step S202).

As described above, based on high-frame-rate images, the encoding apparatus 20 encodes low-frame-rate images for deriving medium-frame-rate images. Based on high-frame-rate images, the encoding unit 201 derives low-frame-rate images, medium-frame-rate images, and weights. The encoding unit 201 encodes the low-frame-rate images and weights. Here, the encoding unit 201 derives a medium-frame-rage image by compositing a first frame and a second frame that are chronologically contiguous in low-frame-rate images based on weights. The encoding unit 201 derives low-frame-rate images and weights so as to minimize the degree of deviation between a plurality of frames of high-frame-rate images in a preset period (stage) and a plurality of frames of medium-frame-rate images in that period.

In this way, the encoding unit 201 derives low-frame-rate images and weights so as to minimize the degree of deviation between a plurality of frames of high-frame-rate images in a preset period (stage) and a plurality of frames of medium-frame-rate images in that period. This enables selection of a coefficient of a temporal filter that improves the encoding efficiency of low-frame-rate images that are generated from high-frame-rate images.

The encoding apparatus 20 may derive the amount of generated codes of frames to be encoded in low-frame-rate images after temporal filtering has been performed with respect to high-frame-rate images. The encoding apparatus 20 may derive a weighted sum of the amounts of deviation between frames to be encoded and a frame group of high-frame-rate images at a temporal position corresponding to a temporal position of these frames to be encoded. The encoding apparatus 20 may derive a weighted sum of the degrees of deviation between display frames and frame groups of high-frame-rate images. The encoding apparatus 20 may select, from the collection of filter coefficients (dictionary), a filter coefficient that minimizes at least one of the weighted sum of the amounts of deviation and the weighted sum of the degrees of deviation. The encoding apparatus 20 may select a filter coefficient that minimizes the accumulated value of the weighted sum (cost value) on a per-frame basis for low-frame-rate images.

While the embodiment of the present invention has been described above in detail with reference to the drawings, specific configurations are not limited to this embodiment, and the designs and the like within a scope that does not depart from the principles of the present invention are also possible.

### INDUSTRIAL APPLICABILITY

The present invention is applicable to an encoding apparatus and a decoding apparatus for images.

### REFERENCE SIGNS LIST

1 Filtering system
2 Filtering apparatus
3 Storage apparatus
4 Processor
Communication apparatus
Encoding apparatus
21 Decoding apparatus
200 Communication unit
201 Encoding unit
202 Dictionary design unit
203 Selection unit
204 Filter
205 Lossless encoder
210 Communication unit
211 Decoding unit

1. A decoding apparatus, comprising:
an obtainment unit in which a high frame rate, a medium frame rate, and a low frame rate have been determined in advance in descending order of frame rate, and which obtains low-frame-rate images that are moving images with the low frame rate, as well as weights; and
a decoding unit that generates a third frame of medium-frame-rate images that are moving images with the medium frame rate by compositing a first frame and a second frame that are chronologically contiguous in the low-frame-rate images based on the weights,
wherein the low-frame-rate images and the weights are derived in advance so as to minimize a degree of deviation between a plurality of frames of moving images with the high frame rate in a preset period and a plurality of frames of the medium-frame-rate images in the period.

2. The decoding apparatus according to claim 1,
wherein the low-frame-rate images and the weights are derived in advance so as to further minimize an amount of codes of the low-frame-rate images.

3. An encoding apparatus in which a high frame rate, a medium frame rate, and a low frame rate have been determined in advance in descending order of frame rate, and which, based on high-frame-rate images that are moving images with the high frame rate, encodes low-frame-rate images that are moving images with the low frame rate for deriving medium-frame-rate images that are moving images with the medium frame rate, the encoding apparatus comprising:
an encoding unit that derives the low-frame-rate images, the medium-frame-rate images, and weights based on the high-frame-rate images, and encodes the low-frame-rate images and the weights,
wherein the encoding unit
derives the medium-frame-rate images by compositing a first frame and a second frame that are chronologically contiguous in the low-frame-rate images based on the weights, and
derives the low-frame-rate images and the weights so as to minimize a degree of deviation between a plurality of frames of the high-frame-rate images in a preset period and a plurality of frames of the medium-frame-rate images in the period.

4. The encoding apparatus according to claim 3,
wherein the encoding unit derives the low-frame-rate images and the weights so as to further minimize an amount of codes of the low-frame-rate images.

5. A decoding method executed by a decoding apparatus, the decoding method comprising:
obtaining low-frame-rate images that are moving images with a low frame rate, as well as weights, wherein a high frame rate, a medium frame rate, and the low frame rate have been determined in advance in descending order of frame rate; and
generating a third frame of medium-frame-rate images that are moving images with the medium frame rate by compositing a first frame and a second frame that are chronologically contiguous in the low-frame-rate images based on the weights,
wherein the low-frame-rate images and the weights are derived in advance so as to minimize a degree of deviation between a plurality of frames of moving images with the high frame rate in a preset period and a plurality of frames of the medium-frame-rate images in the period.

6. (canceled)

7. A non-transitory computer-readable medium having computer-executable instructions that, upon execution of the instructions by a processor of a computer, cause the computer to function as the decoding apparatus of claim 1.
